(19) United States
(12) Patent Application Publication
(10) Pub. No.: US 2025/0205823 A1
(43) Pub. Date: Jun. 26, 2025

(54) CLAMPING JIG APPARATUS FOR SECONDARY BATTERY ELECTRODE PLATE PROCESSING AND ELECTRODE PLATE PROCESSING METHOD USING THE SAME

(71) Applicant: SAMSUNG SDI CO., LTD., Yongin-si (KR)

(72) Inventor: DONGMIN SHIN, Yongin-si (KR)

(21) Appl. No.: 18/968,012

(22) Filed: Dec. 4, 2024

(30) Foreign Application Priority Data
Dec. 21, 2023 (KR) 10-2023-0188938

(51) Int. Cl. B23K 26/38; B23K 37/04; B23K 101/36; H01M 4/04

(52) U.S. Cl. CPC B23K 26/38; B23K 37/0408; B23K 37/0443; H01M 4/0433; B23K 2101/36

(57) ABSTRACT

A secondary battery electrode plate processing jig apparatus is provided and an electrode plate processing method using the same is also provided. The secondary battery electrode plate processing jig apparatus includes: a base portion; a rotating plate rotatably installed on an upper portion of the base portion; a driving portion that provides a rotational driving force to the rotating plate; and a plurality of clamping portions installed on the rotating plate. Each of the clamping portions is configured to clamp an electrode plate such that the electrode plate can be transported to a plurality of processing positions. A controller controls each of the clamping portions to clamp electrode plates according to a process of the electrode plate and control the driving portion to rotate the rotating plate according to the process.

### CROSS-REFERENCE TO RELATED APPLICATION

This application claims priority to and the benefit of Korean Patent Application No. 10-2023-0188938 filed in the Korean Intellectual Property Office on Dec. 21, 2023, the entire contents of which are incorporated herein by reference.

### BACKGROUND

### (a) Field

The present disclosure relates to a clamping jig apparatus for secondary battery electrode plate processing that may stably collect a scrap occurring during an electrode plate cutting process, and an electrode plate processing method using the same.

### (b) Description of the Related Art

During a secondary battery manufacturing process, there is a notching process in which an electrode plate is cut into a desired shape. Molds or lasers are often used for cutting the electrode plate.

The cutting of the electrode plate using the mold has a disadvantage in that cutting quality often deteriorates due to wear on the mold when it is used for a long period of time, and maintenance costs of the mold are high as polishing or replacement is required at regular intervals.

On the other hand, the cutting of the electrode plate using the laser notching has an advantage in that there is no change in quality over time and that the processing shape may be automatically changed.

In the laser notching method, it is important to fix the electrode plate at the focal position of the laser during processing. That is, when the electrode plate deviates from the focal position, the energy density per area is decreases, such that the electrode plate is not cut or the quality of the cut surface deteriorates.

In addition, it is important to cut off the electrode plate and then collect the remaining portion (hereinafter referred to as scrap). When the scraps are leaked and mixed into a battery in which the electrode plate is used, there is a problem that a separator is damaged, causing damage to the battery.

Conventional technology applies a method of absorbing scrap by a vacuum unit, transporting it to a space separate from the processing position, and then releasing the vacuum. Conventional technology also uses a method of collecting scrap by sucking it with a suction device.

However, conventional scrap collecting methods have a problem in that scrap collection may not be performed when a pipe of the vacuum or suction device is clogged, which results in an instantaneous decrease in vacuum pressure.

### SUMMARY

An embodiment of the present disclosure provides a clamping jig apparatus for secondary battery electrode plate processing (hereinafter also referred to as a secondary battery electrode plate processing jig apparatus) that may smoothly cut an electrode plate and remove scrap by rotating the electrode plate according to a processing position of the electrode plate while fixing the electrode plate to a clamping portion, and an electrode plate processing method using the same.

An embodiment of the present disclosure provides a secondary battery electrode plate processing jig apparatus, including: a base portion; a rotating plate rotatably installed on an upper portion of the base portion; a driving portion that provides a rotational driving force to the rotating plate; a plurality of clamping portions installed on the rotating plate, each of the clamping portions being configured to clamp an electrode plate such that the electrode plate can be transported to a plurality of processing positions; and a controller that is configured to control each of the clamping portions in a process with one or more of the electrode plates and controls the driving portion to rotate the rotating plate according to the process.

The base portion may include a base plate installed in an electrode plate processing work space; and a support portion protruding from an upper portion of the base plate and rotatably supporting the rotating plate.

The support portion may include a post member protruding from an upper portion of the base plate; and a first bracket protruding from a side surface of the post member and fixed to a rotational center position of the rotating plate.

A second bracket supporting the driving portion may protrude from the side surface of the post member.

The driving portion may be a driving motor that is installed on the base plate, with the driving motor including a driving shaft that passes through the second bracket to be connected to the rotational center position of the rotating plate.

Each of the clamping portions may include a plurality of cylinder members installed on an upper surface of the rotating plate; and a pair of pressing jigs that are operatable to move closer to or more spaced apart from each other by an operation of the cylinder member to clamp the electrode plate.

Each of the cylinder members may include a plurality of cylinder bodies installed on an upper portion of the rotating plate; and a pair of rod members installed on the cylinder bodies and connected to the pair of pressing jigs.

Each of the pressing jigs may include a jig plate configured to press and fix opposing surfaces of the electrode plate while contacting the opposing surfaces of the electrode plate.

A cutting line corresponding to a cutting shape of the electrode plate may be formed at an edge of the jig plate.

A pair of guide plates may be installed on a side surface of the pressing jig to guide movement of the electrode plate in a direction of the pressing jig.

The electrode plate fixed to the clamping portion may be cut to a set size by a laser cutter.

A scrap sensor may be provided to check whether a scrap cut from the electrode plate is removed, and the scrap sensor may be installed at a position spaced apart from a side surface of the rotating plate.

The scrap sensor may be an optical sensor and irradiates light in to check whether the scrap is removed.

The secondary battery electrode plate processing jig apparatus may further include a scrap collector configured to collect the scrap when the scrap sensor senses the scrap.

The scrap collector may include a hood portion installed at a scrap collecting position and having an opening on one side thereof through which the scrap is introduced; and a discharge portion protruding from the other side of the hood portion to discharge the scrap.

The secondary battery electrode plate processing jig apparatus may further include a scanner configured to sense an operating state of the clamping portion and to transmit a sensing signal to the controller.

Another embodiment of the present disclosure provides a method of processing a secondary battery electrode plate under control of the controller, the method including: (a) controlling a clamping portion of a jig apparatus to fix the electrode plate; (b) cutting the fixed electrode plate to a set size; (c) rotating the rotating plate (d) determining whether a scrap cut from the electrode plate is present; and (e) rotating the rotating plate to a position where the scrap is collected using a scrap collector.

In step (d), after releasing the electrode plate fixed by the clamping portion and collecting the scrap using the scrap collector, the electrode plate may be further rotated by the rotating plate.

According to the embodiment of the present disclosure, it is possible to transport an electrode plate and cut the electrode plate to a set size, and it is possible to smoothly collect scraps occurring during the cutting process of the electrode plate to a collection position. Therefore, it is possible to effectively prevent manufacturing defects from occurring by damaging a separator and the like due to introduction of scrap during a manufacturing process of a battery.

### BRIEF DESCRIPTION OF THE DRAWINGS

FIG. 1 illustrates a schematic perspective view of a secondary battery electrode plate processing jig apparatus according to an embodiment of the present disclosure.

FIG. 2 illustrates a schematic top plan view of the secondary battery electrode plate processing jig apparatus of FIG. 1.

FIG. 3 illustrates a schematic flowchart of a method of processing an electrode plate under the control of a controller according to an embodiment of the present disclosure.

FIG. 4 illustrates a schematic perspective view of a state of fixing an electrode plate using a clamping part of a secondary battery electrode plate processing jig apparatus according to an embodiment of the present disclosure.

FIG. 5 illustrates a schematic perspective view of a state in which the electrode plate fixed by the clamping portion in FIG. 4 is cut to a predetermined size.

FIG. 6 illustrates a schematic perspective view of the sensing of a scrap occurrence state using a scrap sensor in the cutting state of the electrode plate in FIG. 5.

FIG. 7 illustrates a schematic perspective view of a state of collecting scrap occurring in FIG. 6.

### DETAILED DESCRIPTION OF THE EMBODIMENTS

The present disclosure will be described more fully hereinafter with reference to the accompanying drawings, in which embodiments are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

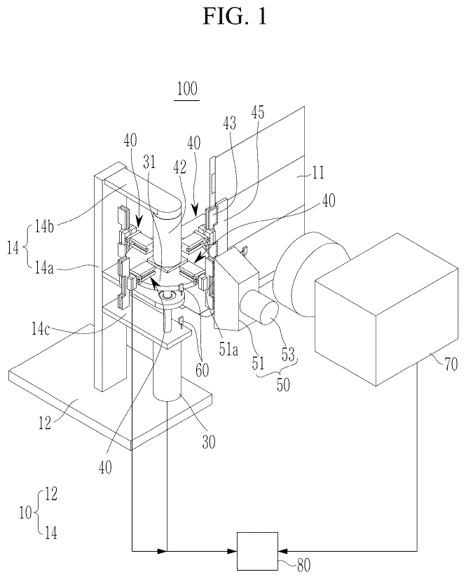

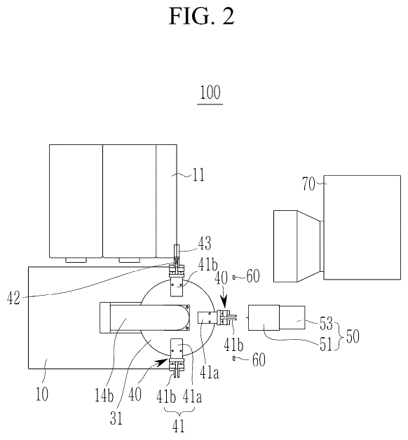

FIG. 1 illustrates a schematic perspective view of a clamping jig apparatus for secondary battery electrode plate processing according to an embodiment of the present disclosure. FIG. 2 illustrates a schematic top plan view of the clamping jig apparatus for secondary battery electrode plate processing of FIG. 1.

As illustrated in FIG. 1 and FIG. 2, a clamping jig apparatus 100 for secondary battery electrode plate processing according to an embodiment. The secondary battery electrode plate processing jig apparatus 100 transports and processes electrode plates to a plurality of processing positions, and may include a base portion 10, a rotating plate 31 rotatably installed on an upper portion of the base portion 10, a driving portion 30 that provides rotational driving force to the rotating plate 31, a plurality of clamping portions 40 installed on the rotating plate 31 and clamping an electrode plate 11 to transport it to a plurality of processing positions, and a controller 80 that controls the clamping portion 40 according to a processing process of the electrode plate 11 to clamp the electrode plate 11 and controls the driving portion 30 to rotate the rotating plate 31 according to the processing process.

The base portion 10 is installed on a surface of an electrode plate processing work space, and the rotating plate 31 may be rotatably installed thereon.

The base portion 10 may include a base plate 12 installed in the electrode plate processing work space, and a support portion 14 protruding from an upper portion of the base plate 12 and rotatably supporting the rotating plate 31.

The base plate 12 is installed on the surface of the electrode plate working space, and may be installed in a polygonal shape such as a substantially rectangular shape or a substantially square shape. Of course, the base plate 12 is not limited to a polygonal shape and may also have a round shape.

The support portion 14 may protrude from an upper portion of the base plate 12. The support portion 14 protrudes upward from the approximate center of gravity of the base plate 12, so that the rotating plate 31 may be rotatably installed.

More specifically, the support portion 14 may include a post member 14a protruding from the upper portion of the base plate 12 and a first bracket 14b protruding from the side surface of the post member 14a and fixed to the rotational center position of the rotating plate 31. The post member 14a may protrude upward from an approximate center of gravity of the base plate 12. The first bracket 14b may protrude from the side surface of the post member 14a. The first bracket 14b protrudes from one side of the upper end of the post member 14a, and the rotating plate 31 may be rotatably installed at the protruding end position.

The rotating plate 31 is rotatably installed on the protruding lower portion of the first bracket 14b, and a pneumatic manifold 42 for supplying pneumatic air to the clamping portions 40 (to be described later) may be installed between the protruding lower portion of the first bracket 14b and the rotating plate 31. That is, the rotating plate 31 is installed through the pneumatic manifold 42 under the first bracket 14b, and a bearing (not shown) or the like may be installed at the end of the pneumatic manifold 42 to be rotatably installed on the first bracket 14b. The pneumatic manifold 42 will be described in more detail below.

The driving portion 30 may be installed while supported on the base portion 10 to provide rotational driving force to the rotating plate 31. The driving portion 30 may be applied as a driving motor that is installed on the base plate 12 and have a driving shaft 32 that passes through a second bracket 14c to be connected to the rotational center position of the rotating plate 31. Hereinafter, the same reference number is used for the driving portion and the driving motor.

To install the driving motor 30, the second bracket 14c may protrude from the side surface of the post member 14a. One side of the second bracket 14c protrudes while being connected to the side surface of the post member 14a, and may be installed on the side surface of the post member 14a to support the driving shaft 32 portion of the driving motor 30. That is, the driving motor 30 may be installed such that the lower portion thereof is supported by the base plate 12, and the driving shaft 32 of the upper portion thereof passes through the second bracket 14c to be connected to the rotating plate 31.

The plurality of clamping portions 40 that clamp the electrode plate 11 may be installed on the upper side of the rotating plate 31. The plurality of clamping portions 40 are radially installed on the upper surface of the rotating plate 31, and may be installed to transport the plurality of electrode plates 11 to the plurality of processing work positions according to the rotational operation of the rotating plate 31. More specifically, each of the clamping portions 40 may include a plurality of cylinder members 41 installed radially on the upper surface of the rotating plate 31, and a pressing jig 43 that clamps the electrode plate 11 by the operation of the cylinder members 41. Each of the cylinder members 41 may include a cylinder bodies 41a installed on the upper portion of the rotating plate, and a pair of rod members 41b installed on the cylinder body 41a and connected to a pair of pressing jigs 43, respectively.

Four cylinder bodies 41a may be installed and extend radially on the upper surface of rotating plate 31. Thus, four electrode plates 11 may be simultaneously clamped and transported. Of course, the number of cylinder bodies 41a is not necessarily limited to four, and the number of cylinder bodies 41a may be changed to an appropriate number depending on the number of electrode plates to be simultaneously transported.

The rod members 41b are moved close to each other according to the operation of the cylinder member 41. The rod members 41b may be installed to enable the operation of the pressing jig 43, which will be described later. The pressing jig 43 may be installed on the pair of rod members 41b and may be operated closer to or spaced apart from each other depending on the operation of the cylinder member 41 to clamp the electrode plate 11. The pressing jig 43 is configured to press opposing sides of the electrode plate 11, and the pressing jig 43 may fix the electrode plate 11 by pressing with surface contact on each of the opposing surfaces of the electrode plate 11. More specifically, the pressing jig 43 may include a jig plate pressed and fixed to the opposing surfaces of the electrode plate 11 in a state in which the jig 43 and the electrode plate 11 are in surface contact with each other. A cutting line 43a corresponding to the cutting shape of the electrode plate 11 may be formed on the side surface of the pressing jig 43. That is, the cutting line 43a is curved along the side edge of the jig plate 43, and the laser irradiated from the laser cutter may move along the cutting line 43a to guide the electrode plate 11 to be properly cut into a set shape and size. Hereinafter, the same reference number is used for the pressing jig and the jig plate.

The cylinder member 41 may be a pneumatic cylinder in the present embodiment. For the operation of the cylinder member 41, the pneumatic manifold 42 may be installed at a position between the rotating plate 31 and the second bracket 14c.

The pneumatic manifold 42 is installed between the rotating plate 31 and the first bracket 14b at a position between the plurality of cylinder members 41. The pneumatic manifold 42 may supply of air to the cylinder member 41 and rotatable installation of the rotating plate 31.

Guide plates 45 may be positioned on a side surface of the pressing jig 43 to guide the electrode plate 11 to move in the direction of the pressing jig 43. The guide plates 45 may be a pair of plates spaced apart from each other to guide the electrode plates 11 to move in the direction of the pressing jig 43. The guide plates 45 may guide the movement of the electrode plate 11 and cover a portion of the electrode plate 11 at the edge of the pressing jig 43. As such, the guide plates 45 may prevent foreign substances from contaminating the electrode plate 11 during the process of cutting the electrode plate by laser processing. In addition, a suction device (not illustrated) or a blow device (not illustrated) may be further installed at the position of the guide plate 45 to prevent foreign substances from contaminating the electrode plate.

As described above, the plurality of electrode plates 11 may be sequentially transported to a plurality of processing positions while being fixed by the plurality of clamping portions 40 installed on the rotating plate 31, thereby performing the electrode plate processing operation.

According to the driving control of the driving motor 30 for rotating the rotating plate 31 and the driving control of the clamping portion 40, the plurality of electrode plates may be sequentially transported to the electrode plate processing position, thereby performing the electrode plate processing operation.

The driving control of the driving motor 30 and the clamping portion 40 may be performed by the controller 80 (to be described later). The controller 80 may drive and control the driving motor 30 and the clamping portion 40, respectively, transport the electrode plate 11 in a clamped state such that the electrode plate 11 can be cut into an appropriate size using a laser cutter (not shown), and control such that a scrap 11a occurring from the cut electrode plate 11 may be removed.

For this purpose, a laser cutter (not shown) is provided in a position close to the rotating plate 31, and a scrap collector 50 that senses and removes the scrap 11a may be provided. Hereinafter, the laser cutter (not shown) is a known configuration, and descriptions of specific configuration and operation thereof will be omitted.

The scrap collector 50 is installed to collect the scrap 11a cut from the electrode plate 11 to a removal position. The scrap collector 50 may be installed to collect the scrap 11a by suction (vacuum pressure). Alternatively, the scrap collector 50 may be installed so that the scrap 11a is moved and discharged by the weight of the scrap 11a itself.

The scrap collector 50 may include a hood portion 51 installed at the scrap collecting position and have an opening 51a at one side of the scrap collector 50 through which the scrap 11a is introduced. A discharge portion 53 protrudes from an opposite side of the hood portion 51 to discharge the scrap 11a. The hood portion 51 is formed with the opening 51a expanding in the direction of the rotating plate 31, and may be installed so that the scrap 11a cut from the electrode plate 11 may be stably introduced into the hood portion 51 and be easily discharged through the discharge portion 53. The discharge portion 53 is formed at a position that faces the opening 51a, and the discharge portion 53 may protrude from a side surface of the hood portion 51 in a pipe shape. A collection line (not shown) is connected to the discharge portion 53 so that the scrap 11a may be collected at a predetermined position.

The scrap collector 50 may be operated using the scrap sensor 60 to sense whether the scrap 11a has been removed. The scrap sensor 60 may be installed at a position spaced apart from the side surface of the rotating plate 31, and may be installed to check whether the scrap 11a is removed by irradiating a laser in the direction of the pressing jig 43.

It is also possible to install a scanner 70 that senses the operating state of the clamping portion 40 and transmits a sensing signal to the controller 80 (described below). The scanner 70 may scan an operation using the clamping portion 40 and a rotation state of the rotating plate 31 and transmit the scan results to the controller 80.

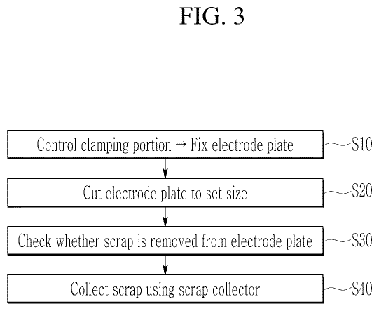

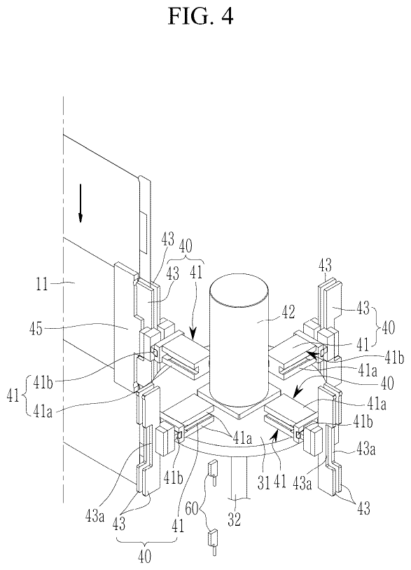

A method of processing an electrode plate under the control of the controller 80 of the secondary battery electrode plate processing jig apparatus 100 of the present embodiment having the above configuration will be described. FIG. 3 illustrates a schematic flowchart of processing an electrode plate under the control of a controller according to an embodiment of the present disclosure, and FIG. 4 illustrates a schematic perspective view of a state of fixing an electrode plate using a clamping part of a clamping jig apparatus for secondary battery electrode plate processing according to an embodiment of the present disclosure.

As shown in FIG. 3 and FIG. 4, the controller 80 controls the plurality of clamping portions 40 to fix the electrode plate 11 transported in the direction of the secondary battery electrode plate processing jig apparatus 100 (S10). In step S10, the electrode plate 11 transported to the position of the secondary battery electrode plate processing jig apparatus 100 by a predetermined transporting device may be fixed using the clamping portion 40.

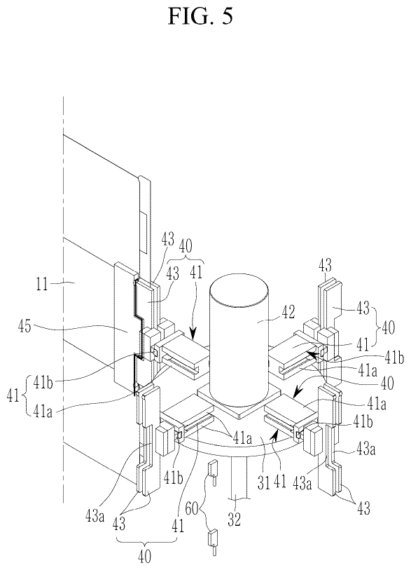

FIG. 5 illustrates a schematic perspective view of a state in which the electrode plate fixed by the clamping portion in FIG. 4 is cut to a predetermined size.

As shown in FIG. 5, the electrode plate 11 fixed in step S10 is cut to a set size (S20). That is, in step S20, the electrode plate 11 fixed by the clamping portion 40 in step S10 may be cut to a set size using a laser cutter (not shown) along the cutting line 43a.

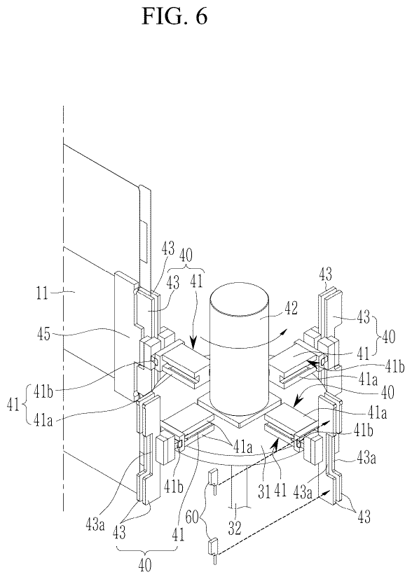

FIG. 6 illustrates a schematic perspective view of the sensing a scrap occurrence using a scrap sensor in during a cutting process of the electrode plate in FIG. 5. As shown in FIG. 6, the rotating plate 31 is rotatably driven to check whether scraps are removed from the electrode plate 11 cut in step S30. That is, in step S30, whether the scrap 11a is removed from the cut electrode plate 11 may be sensed by using the scrap sensor 60.

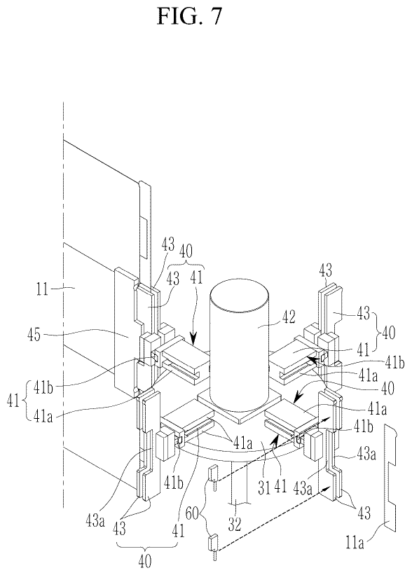

FIG. 7 illustrates a schematic perspective view of a state of collecting scrap occurring in FIG. 6. As shown in FIG. 7, the rotating plate 31 is driven to rotate and the scrap identified in step S30 is collected using the scrap collector 50 (S40). That is, in step S40, the driving motor 30 is driven by the control of the controller 80 to rotate the rotating plate 31 at a set angle, and then the scrap 11a may be transported to the collecting position. In step S40, the clamping portion 40 is released, and the scrap 11a is collected using the scrap collector 50. That is, in step S40, the electrode plate 11 cut to the set size and shape in step S20 is unfastened and transported to the transporting position, and the scrap 11a occurring from the electrode plate 11 may be collected to the collection position using the scrap collector 50.

As described above, the secondary battery electrode plate processing jig apparatus 100 of the present embodiment may transport the electrode plate 11 and appropriately cut the electrode plate 11 to a set size. The electrode plate processing jig apparatus 100 may smoothly collect the scrap 11a from the electrode plate 11 occurring during the cutting process of the electrode plate 11 at the collection position. Therefore, it is possible to effectively prevent manufacturing defects from occurring by damaging a separator and the like due to introduction of scrap during a manufacturing process of a battery.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: base portion
11: electrode plate
11a: scrap
12: base plate
14: support portion
14a: post member
14b: first bracket
14c: second bracket
30: driving portion, driving motor
31: rotating plate
32: driving shaft
40: clamping portion
41: cylinder member
41a: cylinder body
41b: rod member
42: pneumatic manifold
43: pressing jig
43a: cutting line
45: guide plate
50: scrap collector
51: hood portion
51a: opening
53: discharge portion
60: scrap sensor
70: scanner
80: controller

What is claimed is:

1. A secondary battery electrode plate processing jig apparatus comprising:
a base portion;
a rotating plate rotatably installed on an upper portion of the base portion;
a driving portion that provides a rotational driving force to the rotating plate;
a plurality of clamping portions installed on the rotating plate, each of the clamping portions being configured to clamp an electrode plate such that the electrode plate can be transported to a plurality of processing positions; and
a controller configured to control each of the clamping portions in a process with one or more of the electrode plates and control the driving portion to rotate the rotating plate according to the process.

2. The secondary battery electrode plate processing jig apparatus of claim 1, wherein the base portion includes:
a base plate installed in an electrode plate processing work space; and
a support portion protruding from an upper portion of the base plate and rotatably supporting the rotating plate.

3. The secondary battery electrode plate processing jig apparatus of claim 2, wherein the support portion includes:
a post member protruding from an upper portion of the base plate; and
a bracket protruding from a side surface of the post member and fixed to a rotational center position of the rotating plate.

4. The secondary battery electrode plate processing jig apparatus of claim 3, wherein the bracket is a first bracket and a second bracket supporting the driving portion protrudes from the side surface of the post member.

5. The secondary battery electrode plate processing jig apparatus of claim 4, wherein the driving portion is a driving motor that is installed on the base plate, the driving motor including a driving shaft that passes through the second bracket to be connected to the rotational center position of the rotating plate.

6. The secondary battery electrode plate processing jig apparatus of claim 5, wherein each of the clamping portions includes:
a plurality of cylinder members installed on an upper surface of the rotating plate; and
a pair of pressing jigs that are operable to move closer to or more spaced apart from each other by an operation of the cylinder member to clamp the electrode plate.

7. The secondary battery electrode plate processing jig apparatus of claim 6, wherein each of the cylinder members includes:
a plurality of cylinder bodies installed on an upper portion of the rotating plate; and
a pair of rod members installed on the cylinder bodies and connected to the pair of pressing jigs.

8. The secondary battery electrode plate processing jig apparatus of claim 7, wherein each of the pressing jigs includes:
a jig plate configured to press and fix opposing surfaces of the electrode plate while contacting the opposing surfaces of the electrode plate, and
a cutting line corresponding to a cutting shape of the electrode plate formed at an edge of the jig plate.

9. The secondary battery electrode plate processing jig apparatus of claim 8, wherein a pair of guide plates are installed on a side surface of the pressing jig to guide movement of the electrode plate in a direction of the pressing jig.

10. The secondary battery electrode plate processing jig apparatus of claim 9, wherein the secondary battery electrode plate processing jig apparatus is configured such that the electrode plate fixed to each of the clamping portions is cut to a set size by a laser cutter, and
wherein a scrap sensor is provided to check whether a scrap cut from the electrode plate is removed, the scrap sensor being installed at a position spaced apart from a side surface of the rotating plate.

11. The secondary battery electrode plate processing jig apparatus of claim 10, wherein the scrap sensor is an optical sensor and irradiates light to check whether the scrap is removed.

12. The secondary battery electrode plate processing jig apparatus of claim 11, further comprising a scrap collector configured to collect the scrap when the scrap sensor senses the scrap.

13. The secondary battery electrode plate processing jig apparatus of claim 12, wherein the scrap collector includes:
a hood portion installed at a scrap collecting position and having an opening on one side thereof through which the scrap is introduced; and
a discharge portion protruding from the other side of the hood portion to discharge the scrap.

14. The secondary battery electrode plate processing jig apparatus of claim 13, further comprising a scanner configured to sense an operating state of the clamping portion and to transmit a sensing signal to the controller.

15. A method of processing a secondary battery electrode plate under control of the controller of claim 1, the method comprising:
(a) controlling a clamping portion on a rotating plate of a jig apparatus to fix the electrode plate;
(b) cutting the fixed electrode plate fixed to a set size;
(c) rotating the rotating plate;
(d) determining whether a scrap cut from the electrode plate is present; and
(e) rotating the rotating plate to a position where the scrap is collected using a scrap collector.

16. The method of processing the secondary battery electrode plate of claim 15, wherein in step (d), after releasing the electrode plate fixed by the clamping portion and collecting the scrap using the scrap collector, the electrode plate is further rotated by the rotating plate.
